(19) United States
(12) Patent Application Publication
(10) Pub. No.: US 2025/0292440 A1
(43) Pub. Date: Sep. 18, 2025

(54) COMPRESSION AND DECOMPRESSION OF DATA FROM A SYSTEM FOR COMPUTED TOMOGRAPHY

(71) Applicant: Siemens Healthineers AG, Forchheim (DE)

(72) Inventors: Edgar GOEDERER, Forchheim (DE); Andre HENNING, Roethenbach an der Pegnitz (DE); Martin HUPFER, Erlangen (DE); Michael HOSEMANN, Erlangen (DE); Karl STIERSTORFER, Erlangen (DE); Florian WOLZ, Erlangen (DE)

(73) Assignee: Siemens Healthineers AG, Forchheim (DE)

(21) Appl. No.: 19/077,271

(22) Filed: Mar. 12, 2025

(30) Foreign Application Priority Data
Mar. 14, 2024 (DE) 10 2024 202 411.2

(51) Int. Cl. G06T 9/00; H04N 25/30

(52) U.S. Cl. CPC G06T 9/00; H04N 25/30

(57) ABSTRACT

In order to compress data from a system for CT, which has an X-ray detector containing a detector pixel array, a first training dataset is obtained, which contains a pixel value for each of a first multiplicity of detector pixels of the detector pixel array, which pixel value relates to an intensity of X-ray radiation incident on the detector pixel concerned. The first dataset is compressed by applying a first compression module to first input data, which contains the first dataset. The first compression module is comprised by a trained first machine learning model, MLM, which is trained to compress input data via the first compression module, and to reconstruct at least some of the input data based on the compressed input data via a first decompression module of the first MLM.

### CROSS-REFERENCE TO RELATED APPLICATION(S)

The present application claims priority under 35 U.S.C. § 119 to German Patent Application No. 10 2024 202 411.2, filed Mar. 14, 2024, the entire contents of which are incorporated herein by reference.

### FIELD

One or more example embodiments relates to a computer-implemented method for compressing data from a system for computed tomography, CT, and to a corresponding computer-implemented method for decompressing compressed data from a system for CT. One or more example embodiments also relates to a computer-implemented training method for a machine learning model for use in one of said computer-implemented methods for compressing or decompressing data from a system for CT. In addition, one or more example embodiments relates to associated data processing systems, to a corresponding system for CT and to corresponding computer program products.

### RELATED ART

In modern computed tomography, CT, the X-ray detector generates massive amounts of data, which have to be transmitted via a bandwidth-limited connection, in particular from a rotating part of the scanner unit, which carries the X-ray detector, to a stationary part of the scanner unit and on to an image processor for CT reconstruction. The potential data rate to be transmitted can lie in the region of hundreds of Gbit/s.

One option for reducing the amount of data to be transmitted is to use a transfer function to transform the original data from the detector and thereby represent the essential information using a lower bandwidth. For example, a monotonic function of the detector signal can be transmitted instead of the detector signal. One example is taking the logarithm, which exploits the exponential attenuation of the X-ray radiation when passing through material. In this case, the measured radiation intensity is transformed into a metric that is linearly dependent on the absorber length along the path of the X-ray radiation.

Another option is what is known as hybrid data coding (HDC). The intrinsic Poisson distribution of the incident X-ray quanta is used here. This causes a flux-dependent uncertainty in the measured value, which value is scaled by the square-root of the flux. In HDC, the random distribution of this uncertainty is always discretized using the same number of bins. The 1σ neighborhood of the distribution of the random value is thus discretized with a definable number of bins for both small and large flux levels. This saves a large number of bins particularly in the region of high flux levels, thereby lowering the necessary bandwidth. In the small-number range, the root function in the hybrid data coding becomes a linear identity transform.

It is also possible to compress the raw data in time. This exploits the fact that two immediately consecutive X-ray acquisitions normally differ relatively little. Therefore it is possible to encode the difference from the previous image using less bandwidth.

A disadvantage with these known approaches is that the associated data compression is chosen in advance and has to be specifically adapted to the subsequent application. The information lost in the process can no longer be reconstructed from the transmitted signal. Furthermore, the compression is based on a model-assumption about the content and/or use of the data. Thus they are only suitable to a limited extent for data that follows other laws. Moreover, there are considerable differences in the reconstructions in the possible usage cases. A classical CT reconstruction with a coarse slice thickness needs considerably less input data than a very high-resolution spectral reconstruction in photon-counting CT. Hence this requires data encoding designed specifically for each case, or the data encoding is sub-optimum for at least some of the applications.

Autoencoders such as those described, for example, in the publication by G. Hinton, R. Salakhutdinov: “Reducing the Dimensionality of Data with Neural Networks”, Science 313, 504-507(2006), are multi-layer artificial neural networks with a small central layer that can convert the high-dimensional data into low-dimensional codes, and reconstruct the high-dimensional data. The architecture of an autoencoder consists of an encoder module followed by a decoder module. The encoder module forms the input onto a hidden representation, also known as a latent representation or representation in latent space, for example through a plurality of fully connected layers. The decoder module maps the hidden representation back onto the original input space, for example again through fully connected layers. Training of the autoencoder is in particular unsupervised.

A convolutional autoencoder is an autoencoder that uses convolutional layers and pooling layers in the encoder module and decoder module. Like a standard autoencoder, a convolutional autoencoder is trained to reconstruct its input. Convolutional autoencoders are used in particular for image data.

A denoising autoencoder is an autoencoder that is trained to reconstruct the input on the basis of a corrupted version. The aim of the training is to learn a transform that removes the errors from the corrupted input and reconstructs the original input. The term self-supervised training is also used in this context.

A variational autoencoder, VAE, is a generative model, based on the principle of variational inference. It consists of an encoder module, which maps the input data onto a latent space, and a decoder module, which maps the points in the latent space back onto the input space. The aim of the training is to train the weights of the encoder module and of the decoder module such that the decoder module can generate new, synthetic data patterns that are similar to the original input data.

The weights of the encoder and decoder modules can be initialized randomly, for example, and then trained so as to minimize the reconstruction loss, which is a measure of the deviation between the input and the reconstructed output.

All the variants mentioned are referred to generally as “autoencoders”.

### SUMMARY

One or more example embodiments define an alternative option for reducing the amount of data to be transmitted in CT that at least partially overcomes the aforementioned disadvantages.

### BRIEF DESCRIPTION OF THE DRAWINGS

Example embodiments are described in greater detail below with reference to specific exemplary embodiments and associated schematic drawings. In the figures, identical or functionally equivalent elements can be denoted by the same reference signs. The description of identical or functionally equivalent elements is not necessarily repeated when referring to different figures.

In the figures:

FIG. 1 shows a schematic representation of an exemplary embodiment of a system for CT;

FIG. 2 shows a schematic flow diagram of an exemplary embodiment of computer-implemented methods for compressing and decompressing data;

FIG. 3 shows a schematic representation of a convolutional autoencoder for use in further exemplary embodiments of computer-implemented methods for compressing and decompressing data;

FIG. 4 shows a schematic representation of a portion of a detector pixel array of an X-ray detector in a further exemplary embodiment of a system for CT;

FIG. 5 shows a schematic representation of an artificial neural network; and

FIG. 6 shows a schematic representation of a convolutional neural network.

### DETAILED DESCRIPTION

One or more example embodiments is based on the idea of deploying a trained machine learning model, MLM, which is trained to compress input data via a compression module, and to reconstruct at least some of the input data on the basis of the compressed input data via a decompression module. The compression module is applied to a dataset which contains a pixel value for each of a multiplicity of detector pixels of the detector pixel array, which pixel value relates to an energy or an intensity of X-ray radiation incident on the detector pixel concerned.

According to one or more example embodiments, a computer-implemented method is defined for compressing data from a system for CT, also referred to as a CT system. The CT system has an X-ray detector, in particular a CT X-ray detector, which contains a detector pixel array. A first dataset is obtained, in particular from the X-ray detector, the detector pixel array or one or more parts of the detector pixel array. The first dataset contains a pixel value for each detector pixel of a first multiplicity of detector pixels of the detector pixel array, which pixel value relates to an energy or intensity of X-ray radiation incident on the detector pixel concerned. Compressed data is generated by applying a first compression module to first input data, which contains the first dataset. The first compression module is comprised by a trained first machine learning model, MLM, which is trained to compress input data via the first compression module, and to reconstruct at least some of the input data on the basis of the compressed input data via a first decompression module of the first MLM.

Unless stated otherwise, all the steps of the computer-implemented method for compressing data can be performed by a data processing system that includes at least one data processing device. In particular, the at least one data processing device is configured or adapted to execute the steps of the computer-implemented method. For this purpose, the at least one data processing device can store, for example, a computer program containing commands which, when they are executed by the at least one data processing device, cause the at least one data processing device to execute the computer-implemented method. The computer-implemented method can also be implemented entirely or partially in hardware. The expressions “data processing system” and “at least one data processing device” can be used interchangeably here and below. This also applies to corresponding expressions derived therefrom.

For the case in which the at least one data processing device includes two or more data processing devices, certain steps implemented by the at least one data processing device can also be understood to mean that different data processing devices implement different steps or different parts of a step. In particular, it is not necessary for each data processing device to implement the steps. In other words, the implementation of the steps can be distributed over the two or more data processing devices.

The obtaining of the first dataset can comprise, for example, capturing and/or reading a computer-readable data storage medium and/or receiving from a data storage unit, for example a database, and/or receiving a data stream containing the first dataset, for example from the X-ray detector, the detector pixel array or one or more parts of the detector pixel array. The same also applies below to other datasets.

From each embodiment of the computer-implemented method is obtained a corresponding embodiment of a method for compressing data from a CT system, which method is not purely computer-implemented and is obtained by incorporating appropriate steps for generating the first dataset. In such embodiments, the generating of the first dataset can comprise capturing or acquiring, in particular measuring, the first dataset, for instance via the X-ray detector, the detector pixel array or one or more parts of the detector pixel array. The same also applies below to other datasets.

The detector pixel array corresponds to a two-dimensional array of detector pixels, wherein the detector pixels are not necessarily arranged in one plane but can be arranged, for example, on a curved surface, for instance part of an internal face of a spherical surface or of a circular-cylinder shell. In the latter cases, the positions of the individual detector pixels can be given by cylindrical coordinates (ϕ, z) for example. The detector pixels can also be arranged in pixel groups, so that the detector pixel array contains an array of pixel groups, with each pixel group in turn containing a sub-array of individual detector pixels. The individual detector pixels in a pixel group can be immediately adjacent to one another, for example, whereas gaps can be provided between different pixel groups. Other architectures of the detector pixel array are also possible, however.

It is also possible that the detector pixel array has a plurality of hardware components that differ from one another and are likewise arranged in the form of an array. Each hardware component then contains a multiplicity of detector pixels, which can be grouped inside the hardware component, if applicable in pixel groups. Further hierarchical levels are also possible.

The first multiplicity of detector pixels can contain all or some of the detector pixels of the detector pixel array. The detector pixels of the first multiplicity of detector pixels lie in particular in a contiguous spatial region, for instance corresponding to a spatial structure of the detector pixel array. Depending on the design of the detector pixel array and/or choice of the spatial region, said spatial region can also include structural-element borders or spatial gaps between pixel groups and so on. In other words, the spatial region is contiguous in the mathematical sense, and the first multiplicity of detector pixels is, for example, the set of detector pixels located inside the spatial region. The detector pixels of the first multiplicity of detector pixels need not be contiguous in the strict sense, because some can also be spaced apart from one another and/or implemented on different hardware components, as mentioned above. The same also applies below to a multiplicity of other detector pixels unless stated otherwise.

The fact that the at least one first dataset includes a pixel value for each of the first multiplicity of detector pixels does not exclude the first dataset from additionally including one or more further pixel values for each of the first multiplicity of detector pixels. In other words, the at least one first dataset includes at least the pixel value for each of the first multiplicity of detector pixels. The pixel value and, if applicable, the further pixel value(s) can exist as individual scalar values or as entries in one or more vectors, one or more matrices or one or more higher-dimensional tensors. The at least one first dataset, or the pixel values and, if applicable, the further pixel value(s) for the first multiplicity of detector pixels, can be detector raw data from the X-ray detector or preprocessed raw data, for example.

The compressed data is generated by applying the first compression module to the first input data, which contains the at least one first dataset. If the first input data consists of the at least one first dataset, then the compressed data corresponds in particular to the compressed at least one first dataset. In various embodiments, however, it is also possible that the first input data includes, in addition to the at least one first dataset, further data, for example context data. Then although the compressed data does result from, inter alia, the at least one first dataset, it does not necessarily constitute, or not necessarily only constitute, the compressed at least one first dataset. In general, the compressed data can be regarded as the compressed first input data.

As a result of the training of the MLM, its decompression module is capable of reconstructing from the compressed data the first input data at least in part, with the reconstructed part containing at least the reconstructed at least one first dataset. In some embodiments, the further data is not reconstructed. It is also possible, however, for the entire input data to be reconstructed.

The compressed data can thus be regarded as the result of the computer-implemented method for compressing data. This can be transmitted to a further entity and/or stored for later use. The transmitted and/or stored compressed data can then be decompressed via the decompression module, in particular in a method according to one or more example embodiments of the present invention for decompressing compressed data from a CT system, in order to reconstruct the at least one first dataset.

Generally speaking, a trained MLM can mimic cognitive functions that humans associate with another human mind. In particular, as a result of training based on training data, the MLM is capable of adapting to new circumstances and detecting and extrapolating patterns. Another term for a trained MLM is “trained function”.

In general, the parameters of an MLM can be adapted or updated by training. In particular, the terms supervised training, semi-supervised training, unsupervised training, reinforcement learning and/or active learning can be used here. It is also possible to use representation learning, also known as feature learning. In particular, the parameters of the MLMs are adapted iteratively by a plurality of training steps. In particular, a specific loss function, also known as a cost function, can be minimized in the training. The backpropagation algorithm, in particular, can be used in the training of an artificial neural network, ANN.

An MLM can include in particular an ANN, a support vector machine, a decision tree and/or a Bayes network, and/or the MLM can be based on k-means clustering, Q-learning, genetic algorithms and/or association rules. In particular, an ANN can be, or can include, a deep neural network, a convolutional neural network, CNN, or a deep convolutional neural network. In addition, an ANN can be an adversarial network, a deep adversarial network and/or a generative adversarial network.

The first MLM can include an artificial neural network, ANN, for example an autoencoder, in particular a standard autoencoder, a convolutional autoencoder, a denoising autoencoder, or a VAE. In the case of an autoencoder, the compression module is an encoder module of the autoencoder, and the decompression module is a decoder module of the autoencoder.

Instead of an autoencoder, however, the MLM can also be in the form of another ANN, for instance a transformer network or a state space model network.

According to at least one embodiment, the X-ray detector is an integrating X-ray detector, i.e. an X-ray detector that is not a photon-counting X-ray detector. The at least one first dataset contains for each detector pixel of the first multiplicity of detector pixels, as an associated pixel value, a measure of the intensity of the X-ray radiation incident on the detector pixel, integrated over a data acquisition time interval, also known as a detector frame or frame.

The measure of the integrated intensity of the individual detector pixels constitutes in standard, non-photon-counting X-ray detectors a central quantity essential to generating a CT reconstruction. It is therefore particularly advantageous to compress this quantity as described.

According to at least one embodiment, the X-ray detector is a photon-counting X-ray detector.

According to at least one embodiment, the at least one first dataset contains for each detector pixel of the first multiplicity of detector pixels, as an associated pixel value, a corresponding number of count events for the corresponding detector pixel.

The number of count events of the individual detector pixels constitutes in photon-counting X-ray detectors a central quantity essential to generating a CT reconstruction. It is therefore particularly advantageous to compress this quantity as described.

In particular, the count events correspond to a specified energy threshold, in particular a number of detected results each with an energy deposition above the energy threshold. The number of count events thus equals the detected number of events in which X-ray photons incident on the detector pixels exceed the energy threshold. The energy threshold can be chosen such that a single X-ray photon with sufficient energy leads to the energy threshold being exceeded.

According to at least one embodiment, the at least one first dataset contains for each detector pixel of the first multiplicity of detector pixels an associated number of further count events, wherein the further count events correspond to a specified further energy threshold, which differs from the energy threshold.

In other words, the at least one first dataset contains for each detector pixel of the first multiplicity of detector pixels the pixel value and a first further pixel value, which is given by the number of further count events.

The explanations relating to the pixel value and the energy threshold can be applied analogously to the first further pixel value and the further energy threshold.

By virtue of the X-ray detector counting count events at a plurality of energy thresholds, it is possible to achieve spectrally resolved raw data, increasing the opportunities for qualitative and quantitative analysis, in particular of the CT reconstructions. On the other hand, capturing data for a plurality of energy thresholds also increases enormously the potential amount of data to be transmitted or stored. One or more example embodiments of the present invention is therefore particularly advantageous here.

According to at least one embodiment, the at least one first dataset contains for each of the first multiplicity of detector pixels a number of coincidence count events, wherein the X-ray detector is in particular a photon-counting X-ray detector.

Coincidence count events can arise when X-ray photons arrive at a boundary between two or more adjacent detector pixels or close to this boundary, with the result that the two or more detector pixels simultaneously register a count event, and hence the number of counted events in total is greater than the number of photons that have actually arrived. Such effects can be compensated for in the CT reconstruction by taking into account the number of coincidence count events. This increases the image quality that can be achieved in the CT reconstruction. On the other hand, capturing the coincidence count events increases the potential amount of data to be transmitted or stored. One or more example embodiments of the present invention is therefore particularly advantageous here.

For example, the at least one first dataset can comprise a first dataset containing the pixel values and, if, applicable, the further pixel values, and also a further first dataset containing the number of coincidence count events.

According to at least one embodiment, the at least one first dataset contains for each of the first multiplicity of detector pixels a number of paralysis compensation events.

Paralysis is an effect in a photon-counting X-ray detector in which a plurality of X-ray photons incident on a detector pixel cannot be separated in time, and therefore are mistakenly captured as just one X-ray photon. It is possible to compensate for this partially, however, by artificially increasing the number of count events if the detected pulses exceed a limit duration, for example. The artificial increase in the number of count events can be called a paralysis compensation event. Other mechanisms for paralysis compensation are also possible, however.

Unwanted effects caused by the paralysis can be compensated for in the CT reconstruction by taking into account the number of paralysis compensation events. This increases the image quality that can be achieved in the CT reconstruction. On the other hand, capturing the paralysis compensation events also increases the potential amount of data to be transmitted or stored. One or more example embodiments of the present invention is therefore particularly advantageous here.

For example, the at least one first dataset can include also a further first dataset containing the number of paralysis compensation events.

According to at least one embodiment, the at least one first dataset contains a cluster value for each of two or more pixel clusters of the first multiplicity of detector pixels, which cluster value relates to the entire pixel cluster concerned and in particular not, or not only, to the individual pixels.

In associated embodiments, a pixel cluster can correspond to one or more of the aforementioned pixel groups, or a portion of a pixel group. Other possibilities for grouping detector pixels into pixel clusters are also possible, however. A pixel cluster always includes at least two detector pixels. For example, a pixel cluster can correspond to all the pixels of the first multiplicity of detector pixels that lie inside a predefined spatial cluster region.

Thus the cluster value relates to all the detector pixels of the cluster and not to the individual detector pixels as such. Examples of the cluster value include the number of coincidence count events in the entire pixel cluster and the number of paralysis compensation events in the entire pixel cluster.

A further example of the cluster value is the number of random coincidences between two selected pixels of the pixel cluster that are not immediately adjacent. These random coincidences arise, for example, from detecting two independent photons simultaneously by chance. They therefore arise from a different mechanism than the coincidences originating from the multiple detection of a single photon, and therefore carry different information.

Taking into account the cluster values can further increase the image quality that can be achieved in the CT reconstruction. On the other hand, capturing the cluster values also increases the potential amount of data to be transmitted or stored. One or more example embodiments of the present invention is therefore particularly advantageous here.

According to at least one embodiment, the at least one first dataset contains for each of the first multiplicity of detector pixels a second further pixel value, which relates to an intensity of X-ray radiation incident on the detector pixel concerned, wherein the associated pixel value and the associated second further pixel value correspond to different, in particular directly consecutive, data acquisition time intervals.

In other words, two or more data acquisition time intervals are compressed jointly by the compression module. This is advantageous in particular because the compression module then takes into account typical time correlations between different, in particular consecutive, data acquisition time intervals, resulting in a greater reduction in the amount of data overall without increasing the losses.

The explanations relating to the pixel value and the first further pixel value can be applied analogously to the second further pixel value.

According to at least one embodiment, a context dataset is obtained, which relates to the generation of the at least one first dataset. The first input data includes the context dataset.

The context dataset can include in particular conditions in the generation of the at least one first dataset and/or operating parameters of the CT system in the generation of the at least one first dataset and/or parameters relating to preprocessing of the detector raw data in the generation of the at least one first dataset, and so on.

In particular, the content of the context dataset can be known already before the at least one first dataset is generated. Thus it is possible that although the context dataset is compressed as part of the first input data, it is not reconstructed by the decompression module during the decompression of the compressed data. Nonetheless, the context dataset can influence or guide the compression of the at least one first dataset, and thereby contribute to more efficient compression.

The obtaining of the context dataset can comprise, for example, capturing and/or reading a computer-readable data storage medium and/or receiving from a data storage unit, for example a database, and/or receiving a data stream containing the context dataset, for example from the X-ray detector, the detector pixel array or one or more parts of the detector pixel array.

According to at least one embodiment, the context dataset includes a spatial position of the first multiplicity of detector pixels inside the detector pixel array, in particular cylindrical coordinates of the first multiplicity of detector pixels, for example a center point or other characteristic point of the spatial region that corresponds to the first multiplicity of detector pixels.

The first MLM can thereby be adapted specifically to the spatial position of the first multiplicity of detector pixels inside the detector pixel array, in particular also during training of the first MLM, resulting in more efficient compression.

According to at least one embodiment, the at least one context dataset includes operating parameters of an X-ray source of the CT system.

For example, the operating parameters can include a tube current, a peak kilovoltage, filter parameters of an X-ray filter, a size of a focal point, and so on.

The first MLM can thereby be adapted specifically to the operating parameters used, in particular also during training of the first MLM, resulting in more efficient compression.

According to at least one embodiment, the at least one context dataset includes patient information, in particular patient information relating to a patient who was examined or imaged using the CT system in the generation of the at least one first dataset, or patient information relating to a statistical patient population.

In particular, the patient information can include geometric information relating to the physical dimensions and/or weight of the patient.

The first MLM can thereby be adapted specifically to the patient or patient population, for instance the physical dimensions of the patient, in particular also during training of the first MLM, resulting in more efficient compression.

According to at least one embodiment, the context dataset includes information about preprocessing of detector raw data for generating the at least one first dataset.

The information about preprocessing can include, for example, component tables of the data preparation, defective pixel maps, and so on.

The first MLM can thereby be adapted specifically to the preprocessing used, in particular also during training of the first MLM, resulting in more efficient compression.

According to at least one embodiment, the first multiplicity of detector pixels is a first portion of the detector pixel array. At least one second dataset is obtained, which contains a pixel value for each of a second multiplicity of detector pixels of the detector pixel array, which pixel value relates to an intensity of X-ray radiation incident on the detector pixel concerned, wherein the second multiplicity of detector pixels is a second portion of the detector pixel array. Further compressed data is generated by applying a second compression module to second input data, which contains the at least one second dataset, wherein the second compression module is comprised by a trained second MLM, which is trained to compress input data via the second compression module, and to reconstruct at least some of the input data on the basis of the compressed input data via a second decompression module of the second MLM.

The second portion of the detector pixel array differs from the first portion of the detector pixel array, and in particular does not overlap with the first portion of the detector pixel array.

The explanations relating to the at least one first dataset, in particular to obtaining the first dataset, the first MLM, the first compression module, the first decompression module, the first input data and the compressed data can be applied analogously to the at least one second dataset, the second MLM, the second compression module, the second decompression module, the second input data and the further compressed data.

In such embodiments, different MLMs are used to process the data from two portions of the detector pixel array that are located in different spatial positions. Likewise, each of the MLMs can be trained specifically for the different spatial positions of the two portions of the detector pixel array.

This makes use of correlation in the raw data from spatially close detector pixels in order to achieve more efficient compression without increased losses.

The two portions of the detector pixel array can correspond to different modules, module groups, sensor boards, sensor hybrids, ASICs, ASIC groups, ASG pixel groups (ASG: anti-scattering grid) or other groups of detector pixels that represent a spatial structure of the X-ray detector or of the detector pixel array.

In particular, the two portions of the detector pixel array can also be groups of pixels that lie in a similar distance band from a center of the X-ray detector, for instance on the right and left of the center. The two portions of the detector pixel array can also be, for example, pixels in the region of the center in one case, and outer pixels, i.e. pixels farther away from the center, in the other case. Intermediate levels are also possible. For example, this can be used to model the structure of a bow-tie filter after the X-ray source.

According to one or more example embodiments of the present invention, a computer-implemented method is defined for decompressing compressed data from a CT system, which has an X-ray detector containing a detector pixel array. Compressed data is obtained via the first compression module. At least one reconstructed dataset is generated by applying a first decompression module to the compressed data, wherein the first decompression module is comprised by a trained first machine learning model, MLM, which is trained to compress input data via a first compression module of the first MLM, and to reconstruct at least some of the input data on the basis of the compressed input data via the first decompression module.

Unless stated otherwise, all the steps of the computer-implemented method for decompressing compressed data can be performed by a further data processing system that includes at least one further data processing device. In particular, the at least one further data processing device is configured or adapted to execute the steps of the computer-implemented method. For this purpose, the at least one further data processing device can store, for example, a further computer program containing commands which, when they are executed by the at least one further data processing device, cause the at least one further data processing device to execute the computer-implemented method. The computer-implemented method can also be implemented entirely or partially in hardware.

For the case that the at least one further data processing device includes two or more further data processing devices, certain steps implemented by the at least one further data processing device can also be understood to mean that different further data processing devices implement different steps or different parts of a step. In particular, it is not necessary for each further data processing device to implement the steps. In other words, the implementation of the steps can be distributed over the two or more further data processing devices.

The at least one reconstructed dataset corresponds in particular to the reconstruction of the at least one first dataset. The term reconstruction is not linked here to CT image reconstruction or the like.

The obtaining of the compressed data can comprise, for example, capturing and/or reading a computer-readable data storage medium and/or receiving from a data storage unit, for example a database, and/or receiving a data stream containing the compressed data.

According to at least one embodiment of the computer-implemented method for decompressing compressed data, the compressed dataset is, or was, generated using a computer-implemented method according to one or more example embodiments of the present invention for compressing data.

The steps of the computer-implemented method for compressing data can be regarded as part of the computer-implemented method for decompressing compressed data, for example.

In particular, the method includes in some embodiments conveying the compressed data from the data processing system to the further data processing system.

According to at least one embodiment, the first input data includes the context dataset, and the context dataset is not reconstructed by applying the decompression module to the compressed data.

According to at least one embodiment, at least one reduced dataset is generated by applying a further first decompression module of the trained first MLM to the compressed data. The at least one reduced dataset contains a smaller amount of data than the at least one reconstructed dataset.

The first MLM is trained to compress the input data via the first compression module, and to reconstruct at least some of the input data on the basis of the compressed input data via the further first decompression module.

In other words, the compression module is trained and used as a shared compression module for two or more first decompression modules.

In comparison with the at least one reconstructed dataset, the at least one reduced dataset can correspond to, for example, a larger slice thickness, a lower spatial resolution, a lower temporal resolution, and/or a lower spectral resolution. The at least one reduced dataset and the at least one reconstructed dataset can also correspond to different additions or corrections through other channels, such as coincidences for instance.

This makes it possible to generate in parallel two data streams containing a different amount of data. The at least one reduced dataset can be provided more quickly, for example, than the at least one reconstructed dataset, whereas the latter can allow a higher image quality.

Further embodiments of the computer-implemented method for decompressing compressed data follow directly from the various forms of the computer-implemented method for compressing data, and vice versa. In particular, individual features and associated explanations and advantages relating to the various embodiments concerning the computer-implemented decompressing method can be applied analogously to corresponding embodiments of the computer-implemented compressing method, and vice versa.

According to one or more example embodiments of the present invention, a computer-implemented training method, in particular an unsupervised or self-supervised training method, is defined for a first MLM for use in a computer-implemented method according to one or more example embodiments of the present invention for compressing data and/or decompressing compressed data according to one or more example embodiments of the present invention. A first training dataset is obtained, which contains a pixel value for each of the first multiplicity of detector pixels of the detector pixel array, which pixel value relates to an intensity of X-ray radiation incident on the detector pixel concerned. Compressed data is generated by applying the first compression module to first input training data, which contains the first training dataset. Decompressed data is generated by applying the first decompression module to the compressed data. A specified loss function is evaluated on the basis of the first input training data and the decompressed data. The first MLM, in particular the first compression module and the first decompression module, is updated on the basis of a result of the evaluation of the loss function.

Unless stated otherwise, all the steps of the computer-implemented training method can be performed by a training data processing system that includes at least one training data processing device. In particular, the at least one training data processing device is configured or adapted to execute the steps of the computer-implemented training method. For this purpose, the at least one training data processing device can store, for example, a computer program containing commands which, when they are executed by the at least one training data processing device, cause the at least one training data processing device to execute the computer-implemented training method.

For the case that the at least one training data processing device includes two or more training data processing devices, certain steps implemented by the at least one training data processing device can also be understood to mean that different training data processing devices implement different steps or different parts of a step. In particular, it is not necessary for each training data processing device to implement the steps in full. In other words, the implementation of the steps can be distributed over the two or more training data processing devices.

The obtaining of the training dataset can comprise, for example, capturing and/or reading a computer-readable data storage medium and/or receiving from a data storage unit, for example a database, and/or receiving a data stream containing the training dataset.

According to at least one embodiment of the computer-implemented training method, the at least one training dataset is obtained in the form of at least one sinogram. The decompressed data is generated in the form of at least one further sinogram. The loss function quantifies a deviation of the at least one further sinogram from the at least one sinogram.

An advantage of training at the sinogram level is that the first MLM thereby implements clear and semantic structuring of the latent space.

According to at least one embodiment, the generating of the compressed data, the generating of the decompressed data, and the evaluation of the loss function are carried out during a first training phase. A CT reconstruction is generated on the basis of the at least one sinogram, and a further CT reconstruction is generated on the basis of the at least one further sinogram. During a second training phase, which follows the first training phase, a specified further loss function is evaluated on the basis of the CT reconstruction and the further CT reconstruction, and the MLM is re-updated on the basis of a result of the evaluation of the further loss function.

In such embodiments, the first MLM is thus trained first at the sinogram level, and then at the CT reconstruction level, leading to further refinement of the first MLM. It should be mentioned that the sinograms and further sinograms from the first and second training phases can also be different sinograms or further sinograms.

According to at least one embodiment of the computer-implemented method for compressing data from a CT system, the first MLM is, or was, trained using a training method according to one or more example embodiments of the present invention.

According to at least one embodiment of the computer-implemented method for decompressing compressed data from a CT system, the first MLM is, or was, trained using a training method according to one or more example embodiments of the present invention.

According to one or more example embodiments of the present invention, a data processing system is defined having at least one data processing device, which is adapted to perform a computer-implemented method according to one or more example embodiments of the present invention for compressing data from a CT system.

According to one or more example embodiments of the present invention, a further data processing system is defined having at least one further data processing device, which is adapted to perform a computer-implemented method according to one or more example embodiments of the present invention for decompressing compressed data from a CT system.

According to one or more example embodiments of the present invention, a training data processing system is defined having at least one training data processing device, which is adapted to perform a computer-implemented training method according to one or more example embodiments of the present invention.

In the present disclosure, the terms “data processing system” and “at least one data processing device” can be used interchangeably. A data processing device can be understood to mean in particular a data processing device which contains a processing circuit. Thus the data processing device can process in particular data for performing computing operations. These include, if applicable, also operations for performing indexed accesses to a data structure, for instance to a look-up table (LUT), and also a data processing process implemented in hardware. The data processing can be performed, for example, digitally, via analog circuits and/or via quantum mechanical methods.

The data processing device can contain in particular one or more computers, one or more microcontrollers, and/or one or more integrated circuits, for example one or more application-specific integrated circuits (ASIC), one or more field-programmable gate arrays (FPGA), and/or one or more systems on a chip (SoC). The data processing device can also contain one or more processors, for example one or more microprocessors, one or more central processing units (CPU), one or more graphics processing units (GPU), and/or one or more signal processors, in particular one or more digital signal processors (DSP). The data processing device can also contain a physical or virtual interconnection of computers or other of the aforementioned units.

In various exemplary embodiments, the data processing device contains one or more hardware and/or software interfaces and/or one or more memory units.

A memory unit can be embodied as a volatile data storage medium, for example as a dynamic random access memory (DRAM) or a static random access memory (SRAM), or as a non-volatile data storage medium, for example as a read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random access memory (MRAM), or as a phase-change random access memory (PCRAM).

According to one or more example embodiments of the present invention, a CT system is defined. The CT system has a scanner unit, which has an X-ray detector containing a detector pixel array and in particular has an X-ray source. The CT system has a data processing system according to one or more example embodiments of the present invention and/or a further data processing system according to one or more example embodiments of the present invention.

According to at least one embodiment, the CT system has an analysis unit, which is separate from the scanner unit and contains the further data processing system.

According to at least one embodiment, the X-ray detector has a multiplicity of integrated circuits, wherein each integrated circuit of the multiplicity of integrated circuits contains a portion of the detector pixel array. The trained first MLM is implemented on an integrated circuit of the multiplicity of integrated circuits, in particular entirely or partially in hardware.

The integrated circuits can be ASICs, for example.

The manner in which one or more example embodiments of the present invention achieves the object is described above and below with reference to the claimed systems and with reference to the claimed methods. Features, advantages or alternative embodiments can be associated with the other claimed subject matter, and vice versa. In other words, the claims and embodiments for the systems can be improved by features that are described or claimed in connection with the respective methods. In this case, the functional features of the method are implemented by physical units of the system.

Furthermore, the manner in which one or more example embodiments of the present invention achieves the object is described above and below with reference to methods and systems for compressing and/or decompressing data and with reference to methods and systems for providing a trained MLM. Features, advantages or alternative embodiments can be associated with the other claimed subject matter, and vice versa. In other words, claims and embodiments for providing a trained MLM can be improved by features that are described or claimed in connection with the compressing and/or decompressing of data. In particular, the datasets used in the methods and systems can have the same attributes and features as the corresponding datasets used in the methods and systems for providing a trained MLM, and the trained MLMs provided by the respective methods and systems can be used in the methods and systems for compressing and/or decompressing data.

According to one or more example embodiments of the present invention, a first computer program containing first commands is defined. When the first commands are executed by at least one data processing device, the first commands cause the at least one data processing device to perform a computer-implemented method according to one or more example embodiments of the present invention for compressing data from a CT system.

According to one or more example embodiments of the present invention, a second computer program containing first commands is defined. When the second commands are executed by at least one data processing device, the second commands cause the at least one data processing device to perform a computer-implemented method according to one or more example embodiments of the present invention for decompressing compressed data from a CT system.

According to one or more example embodiments of the present invention, a third computer program containing third commands is defined. When the third commands are executed by at least one data processing device, the third commands cause the at least one data processing device to perform a computer-implemented training method according to one or more example embodiments of the present invention.

The first commands, the second commands and/or the third commands can exist as program code, for example. The program code can be provided, for example, as binary code or assembler and/or as source code of a programming language, for instance C, and/or as program script, for instance Python.

According to one or more example embodiments of the present invention, a computer-readable storage medium is defined, which stores a first computer program according to one or more example embodiments of the present invention, a second computer program according to one or more example embodiments of the present invention and/or a third computer program according to one or more example embodiments of the present invention.

The first, second and third computer programs and the computer-readable storage medium are each computer program products containing the first, second and third commands respectively.

Further features and combinations of features of the example embodiments appear in the figures and the description of the figures and in the claims. In particular, further embodiments of the invention need not necessarily contain all the features of one of the claims. Further embodiments of the invention can have features and combinations of features that are not mentioned in the claims.

FIG. 1 shows schematically an exemplary embodiment of a system for CT 1, also referred to as the CT system 1.

The CT system 1 has a scanner unit 2, also called a gantry, which has an X-ray source 3 and an X-ray detector 4. The X-ray detector 4 contains a detector pixel array and a data processing device 6, which is adapted to perform a computer-implemented method according to one or more example embodiments of the present invention for compressing data from the CT system 1, in particular data generated via the scanner unit 2, for instance by the X-ray detector 4.

X-ray projections can be acquired by the scanner unit 2 from a plurality of directions, and the material composition of the scanned region can be deduced using computer-based reconstruction methods on the basis of the different attenuation of the X-rays through different regions of the object to be imaged, which is brought into the acquisition region of the scanner unit 2 via a patient table 5, for example. The data, which represents, inter alia, the X-ray projections, is generated by the scanner unit 2 and transmitted via a data connection 8 for reconstruction to a further data processing device 7, for example an image processor.

Part of the data connection 8 can be in particular inside the scanner unit 2. In particular, the compression can take place between a rotating internal part of the scanner unit 2, on which X-ray source 3 and X-ray detector 4 are arranged, and a stationary external part of the scanner unit 2.

The further data processing device 7 can likewise be part of the CT system 1. In particular, the further data processing device 7 can be adapted to perform a computer-implemented method according to one or more example embodiments of the present invention for decompressing data.

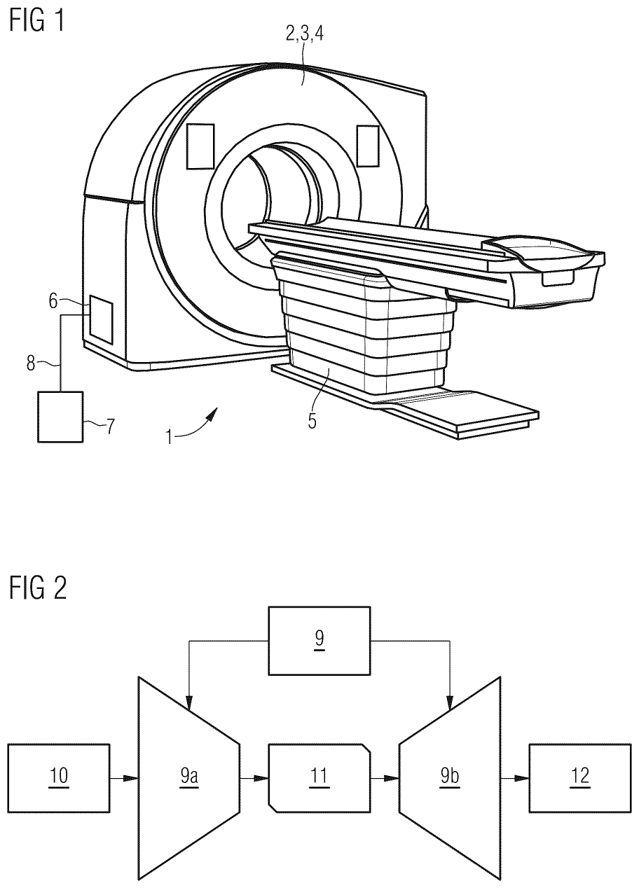

FIG. 2 shows schematically a flow diagram of a computer-implemented method according to one or more example embodiments of the present invention for compressing data, and a computer-implemented method according to one or more example embodiments of the present invention for decompressing data, which methods can be performed, for example, via the CT system 1 of FIG. 1.

A trained machine learning model, MLM, 9 is provided, which has a compression module 9a and a decompression module 9b. The MLM 9 is trained to compress input data via the compression module 9a, and to reconstruct the input data in full or in part on the basis of the compressed input data via the decompression module 9b. For example, a computer-implemented training method can be used according to one or more example embodiments of the present invention for this purpose.

The compression module 9a is implemented in software or in hardware or in a combination thereof on the data processing device 6, which in some embodiments can also be part of the X-ray detector 4. The decompression module 9b is implemented, likewise in software and/or hardware, on the further data processing device 7, which is connected to the data processing device 6 via the data connection 8.

Raw data is generated by the X-ray detector 4 in a known manner. The compression module 9a is applied to input data 10 containing a dataset 10a, 10b, which contains a pixel value for each of a multiplicity of detector pixels 18 of the detector pixel array, which pixel value relates to an energy or intensity of X-ray radiation incident on the detector pixel 18 concerned. The pixel value can be, for example, an associated number of count events for the corresponding detector pixel 18, if the X-ray detector 4 is a photon-counting X-ray detector 4, or a measure of the integrated energy or intensity incident in the form of X-ray radiation on the detector pixel 18 concerned.

In various embodiments, the dataset 10a contains a plurality of pixel values for each of the multiplicity of detector pixels 18, which pixel values relate to the energy or intensity of X-ray radiation incident on the detector pixel 18 concerned. The different pixel values can include, for example, pixel values 10a for different energy thresholds in the case of a photon-counting X-ray detector 4, and/or pixel values 10a for different data acquisition time intervals, also called detector frames, for the same detector pixel 18. For example, the pixel values can be given in the form of one or more scalars, vectors, two-dimensional matrices, or higher-dimensional tensors; for example, a matrix can be given for each pixel value, with the matrix entries corresponding to different detector pixels 18.

In some embodiments, the input data 10 contains a further dataset 10b, which contains at least one cluster value for each of two or more pixel clusters of the first multiplicity of detector pixels 18, which cluster value relates to the entire pixel cluster concerned and in particular not, or not only, to the individual pixels 18.

In some embodiments, in which the X-ray detector 4 is a photon-counting X-ray detector 4, the further dataset 10b alternatively or additionally contains for each of the multiplicity of detector pixels 18 a number of coincidence count events and/or a number of paralysis compensation events.

If the X-ray detector 4 is a photon-counting X-ray detector 4, the at least one cluster value can include, for example, a number of random coincidence count events per pixel cluster and/or a number of paralysis compensation events per pixel cluster.

In some embodiments, the input data 10 contains a context dataset 10c, which relates to the generation of the at least one dataset 10a and/or of the further dataset 10b. For example, the context dataset 10c can include a spatial position of the multiplicity of detector pixels 18 within the detector pixel array, which position is defined in the field of CT in particular by an angular position ¢ with respect to the center point of the gantry and a height z, i.e. by corresponding cylindrical coordinates. The context dataset 10c can include, for example, operating parameters of the X-ray source 3, for instance a tube current and/or a peak kilovoltage and/or a focal-point size and/or one or more filter parameters. For example, the context dataset 10c can also include patient information about the patient to be imaged or a corresponding statistical patient population, for instance geometric patient information. The context dataset 10c can also include, for example, information about preprocessing of the detector raw data for generating the dataset 10a and/or the further dataset 10b.

The compression module 9a generates compressed data 11 as an output to applying the compression module 9a to the input data 10. This compressed data 11 is transmitted to the further data processing device 7. A reconstructed dataset 12a, which, within the accuracy of the MLM 9, corresponds to the dataset 10a, is generated by applying the decompression module 9b to the compressed data 11. In other words, by being applied to the compressed data 11, the decompression module 9b generates output data 12, which includes the reconstructed dataset 12a.

In embodiments in which the input data 10 contains the further dataset 10b, the output data 12 can contain, for example, a further reconstructed dataset 12b, which, within the accuracy of the MLM 9, corresponds to the further dataset 10b.

In some embodiments, in which input data 10 contains the context dataset 10c, the output data 12 contains a reconstructed context dataset, which, within the accuracy of the MLM 9, corresponds to the context dataset 10c. In other embodiments, the output data 12 does not contain a reconstructed context dataset even if the input data 10 contains the context dataset 10c. The context dataset 10c is thus not reconstructed by applying the decompression module 9b to the compressed data 11. In this case, the context dataset 10c is used solely for increasing the performance of the MLM 9 in compressing or reconstructing the datasets 10a, 10b.

The MLM 9 can be in the form of an artificial neural network (ANN), for example. The ANN can be an autoencoder, in particular a convolutional autoencoder, i.e. an autoencoder in the form of a convolutional neural network (CNN), or a variational autoencoder, in particular a convolutional variational autoencoder. The compression module 9a can accordingly also be referred to as an encoder module, and the decompression module 9b as a decoder module. In alternative embodiments, however, the ANN can also be in the form of a transformer network or a state space model network.

FIG. 3 shows the MLM 9 by way of example as a convolutional autoencoder. For example, the compression module 9a has a sequence of encoder stages 13, each containing one or more convolutional layers, for instance followed by a pooling layer. For example, the decompression module 9b has a sequence of decoder stages 14, each containing one or more deconvolutional layers, for instance followed by a pooling layer. The deconvolutional layers can also be referred to as transposed convolutional layers.

It has been described with reference to the figures FIG. 2 and FIG. 3 how the datasets 10a, 10b can be compressed and reconstructed for a multiplicity of detector pixels 18 of the detector pixel array. In principle, the multiplicity of detector pixels 18 can contain all the detector pixels 18 of the detector pixel array or of the X-ray detector 4. In light of the hierarchical or modular design of some X-ray detectors 4, however, it can be advantageous to view different portions of the detector pixel array separately, and to provide each portion with a dedicated compression module 9a. The respectively compressed data 11 can be decompressed by a shared decompression module 9b, or each compression module 9a can be provided with a dedicated decompression module 9b.

In the one case, the size of the individual compression modules 9a and decompression modules 9b can thereby be reduced. In the other case, however, the raw data from different portions of the detector pixel array differ qualitatively, for instance depending on their position in the detector pixel array. Pixel groups at the edge of the detector pixel array can be exposed to other effects than, for instance, pixel groups in the inner region of the detector pixel array, and so on. The training of the particular MLM 9 can accordingly take this into account by selecting the training data appropriately. It is hence possible to improve the performance of the MLM 9, in particular to reduce the information loss in the reconstructed data.

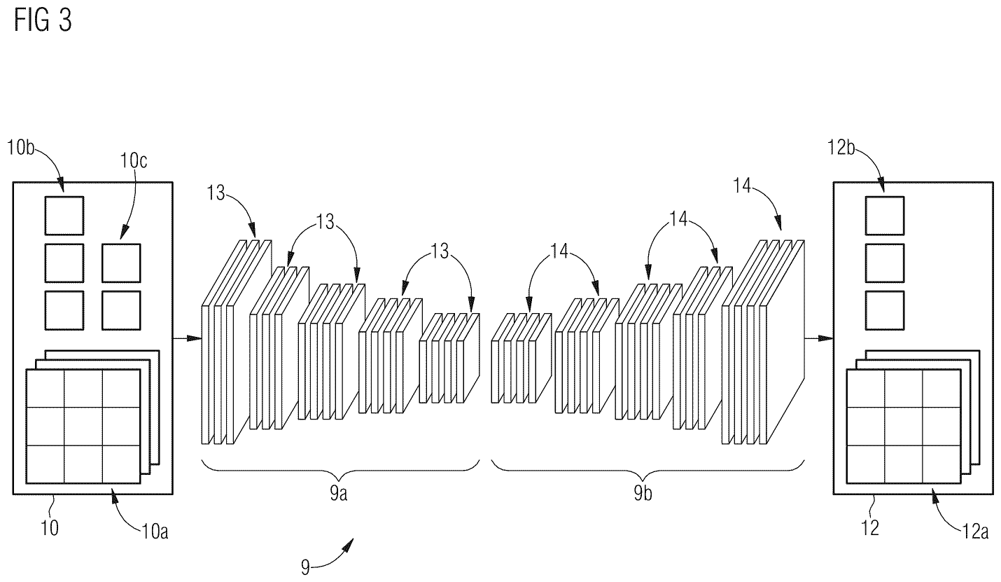

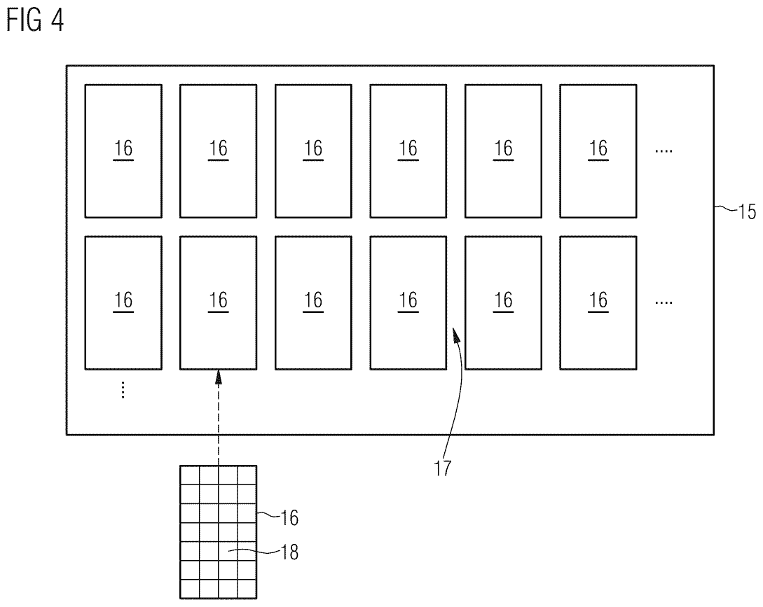

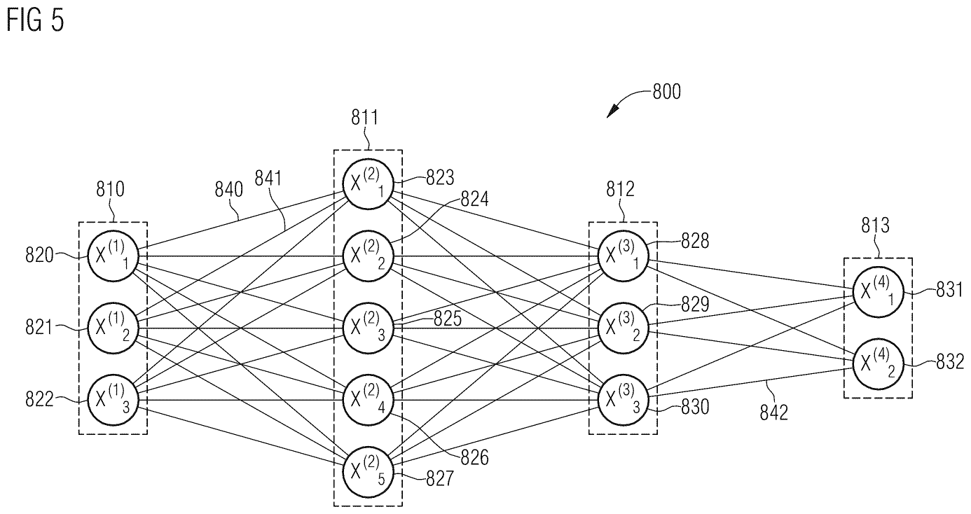

FIG. 4 shows schematically the construction of a detector pixel array or a portion 15 thereof, in particular for a photon-counting X-ray detector 4. The detector pixels 18 are arranged in contiguous pixel groups 16, and the pixel groups 16 are in turn arranged in a hypermatrix. The number of detector pixels 18 per pixel group 16 can differ; in the pixel shown there are 6×4 pixels per pixel group 16. The individual pixel groups 16 can be physically spaced apart from one another, for instance by what is known as an ASG structure 17 (anti-scattering grid).

For example, the detector pixel array can be constructed from a plurality of modules, for instance from a plurality of 10 or 100 modules, with each module having a multiplicity of integrated circuits, in particular ASICS, on which, inter alia, are implemented the detector pixels 18. For example, each module can have 4-64 ASICs or the like. Each ASIC can in turn have a multiplicity of pixel groups 16.

For example, one compression module 9a per pixel group 16 or one compression module 9a per ASIC or per group of ASICs lying in a spatial neighborhood can be provided, or one compression module 9a per module or per group of modules lying in a spatial neighborhood, and so on.

For instance, if one compression module 9a is provided per ASIC, then each compression module 9a can be implemented directly in the ASIC, for example in hardware, in particular using configurable parameters or weights. If one compression module 9a is provided per pixel group 16, then the compression modules 9a for all the pixel groups 16 of an ASIC can be implemented on the ASIC. If one compression module 9a is provided per group of ASICs lying in a spatial neighborhood, then the compression module 9a can be implemented, for example, in a control unit which controls this group of ASICS, for instance an FPGA, and so on.

By handling separately different portions of the detector pixel array that lie in particular in a defined spatial neighborhood, it is advantageously possible to exploit the fact that the raw data from the individual detector pixels 18 are more strongly correlated with one another the closer together the detector pixels 18 lie. The associated MLM 9 can inherently exploit these correlations for compressing the data, i.e. without the correlations being described, or describable, explicitly.

In various embodiments of the invention, by suitable training and adapted dimensioning of the MLM 9, the latent space is just sufficiently formed to obtain the information essential to the reconstruction practically in full.

Depending on the embodiment, various points can come to bear in the implementation. In various embodiments, the input data 10 is not pure input data but includes, for example, a multiplicity of measured variables.

In embodiments in which the X-ray detector 4 is a photon-counting X-ray detector, the input data 10 can include, for example, the entire sub-pixel matrix containing the uncompressed count values for all energy thresholds and further values gathered for individual pixels, such as the number of coincidence count events, the number of added pulses for paralysis compensation, and so on.

In various embodiments, the input data 10 can also include data that is gathered just for each associated pixel group 16, for instance the number of random coincidences per pixel group 16.

In various embodiments, the input data 10 can also include data from a plurality of consecutive frames. This allows typical movement patterns to be modeled in latent space, for instance the optical flow and/or the typically sinusoidal movement patterns.

In various embodiments, the input data 10 can also contain further data as context vectors, for example the spatial position (ϕ, z) in the detector pixel array, scan parameters, header data or further relevant data, for instance an acquisition mode or geometric information about the patient, and also component tables of data preparation (AirCal, defective pixel map, linearization parameters, beam hardening correction, water scaling, et cetera). This context data 10c can be known, for example, already before the start of the measurement, or be defined by the data structure, and can be stored at the receiver end, for example, together with the transmitted data.

In various embodiments, for each compression module 9a are provided a plurality of decompression modules 9b, which can supply different output data, for example output data with a different slice thickness and/or different spatial resolution and/or different temporal resolution and/or different spectral resolution and/or different addition or correction through other channels, for instance coincidences.

In various embodiments, the MLM 9 can be formed for a subset of the detector channels, for instance for a spatial group of modules, for a module, for a sensor board, for a sensor hybrid, for an ASIC, for an ASG pixel, and so on. The variants that are formed per module, per ASIC or per ASG pixel can be particularly advantageous because the compression modules 9a can hence be distributed in parallel over individual modules, or, if applicable, can even be implemented already in the ASIC.

In various embodiments, the subdivision of the detector pixel array and/or the use of the context information also makes it possible to optimize each MLM 9 according to the spatial position in the detector pixel array. Effects of a filter, for instance a bow-tie filter, or the z-position can thereby be taken into account. In particular, it is possible to work with differently optimized MLMs 9 for different spatial regions, or the spatial position can be used as part of the input data. In the latter case, spatial dependencies caused in particular from the bow-tie filter and/or the z-position can be modeled in the latent space of the MLM 9.

Training methods known per se, in particular for unsupervised or self-supervised training, can be employed for training the MLM 9.

A first training dataset is obtained, which contains a pixel value for each of the first multiplicity of detector pixels 18 of the detector pixel array, which pixel value relates to an intensity of X-ray radiation incident on the detector pixel 18 concerned. Compressed data is generated by applying the compression module 9a to input training data, which contains the first training dataset. Decompressed data is generated by applying the decompression module 9b to the compressed data. A specified loss function depending on the first input training data and the decompressed data is evaluated. The MLM 9, in particular the compression module 9a and the decompression module 9b, is updated on the basis of a result of the evaluation of the loss function.

In order to acquire the training data, full detector raw-data, i.e. with full spatial resolution, full temporal resolution, full spectral resolution and full bit depth in all counters, and, if applicable, additional information on coincidences, random coincidences or additions of pulses for paralysis compensation, are first acquired for a series of benchmark cases, for example, and spatially segmented as desired. For example, it is possible to work here initially with simulated raw data and/or phantom measurements.

This data is propagated through the MLM 9 and re-combined spatially into a sinogram. The assessment of the result predicted in this way can take place at two levels: at the sinogram level or at the level of image data reconstructed therefrom. In particular, it is possible in some embodiments to perform basic training initially at the sinogram level, which facilitates clear and semantic structuring of the latent space of the MLM 9. In a second step, the MLM 9 can be refined by training with reconstructed image data.

At both levels, the result from the MLM 9 can be compared with the original data or with the ground truth based thereon. The deviation can be assessed against assessment criteria represented by the loss function, and used as feedback for the training.

The definition of the assessment criteria and the choice of the benchmark datasets or the training data provide a lever that can be used to ensure the suitability of the trained MLM 9. For example, criteria for assessing the deviation with respect to the data reconstructed from the ground truth can be:
an assessment of the deviation from the ground truth by assessing corresponding difference images at the sinogram level or reconstruction level, for instance in terms of magnitude and/or structure of the deviations (for example least squared deviation, existence of lines, bands, rings, and so on);
preservation of the statistical properties of the sinogram data or of the reconstructed image data;
preservation of spatial patterns (for instance “organ delineation”);
preservation of noise intensities and noise patterns, for example in regions of interest specified manually in advance for the training set;
preservation of the Hounsfield Unit values in the regions of interest;
preservation of the image contrast in the regions of interest;
preservation of the spectral contrast in selected regions of interest or in suitable phantoms;
absence of ring or band artifacts;
identifiability of structures and absence of hallucinated structures, for instance calcifications or lung nodules in a human observer model;
minimizing of suitable perceptual loss functions with respect to the ground truth;
preservation of the spatial resolution and/or of the spatial-frequency spectrum; and/or
preservation of the signal stability, for instance over time and/or in the regions of interest.

In particular, a plurality of reconstruction types, for instance VNC, monoenergetic, different convolution kernels, or the like can also be applied in parallel to the data propagated through the MLM 9, and used in the training for the assessment, for instance automated assessment.

If, after the training, unwanted properties, artifacts or hallucinations arise in the evaluation, this can be addressed and corrected via retraining or fine-tuning using suitably extended assessment criteria and/or by including the critical datasets in the training data.

In various embodiments, the data stream that is output by the compression module 9a after the training is in particular configured to allow even the most demanding reconstruction tasks to be realized without losses in the image quality. As a result, the bit-width reduced output stream from the compression module 9a is suitable for any subsequent reconstruction purposes. The use of different decompression modules 9b offers the advantage, for example, that different reconstruction scenarios can make use of an appropriate data stream out of the original data stream from the compression module 9a. For example, this allows a particularly fast, low-resolution reconstruction using a dataset that is suitably reduced for this and which has, for example, a larger slice thickness and contains only scalar data about the radiation intensity. In parallel therewith, a dataset of higher spectral and spatial resolution can be extracted and reconstructed by another decompression module 9b. In addition, when there is a need or clinical indication, the stored data streams can still be used subsequently to shed light on detailed questions.

In various embodiments, the bandwidth needed for the data transmission is minimized so that the entire measured raw-data content relevant in the particular embodiment can be transferred.

In various embodiments, different reconstruction strands can be provided with a compressed data stream by different decompression modules 9b. This achieves an optimum between minimum data bandwidth, high reconstruction speed and availability of information at any level of detail.

Advantageously, selection of the final reconstruction requirement can wait until the later image reconstruction rather than having to be set already before the acquisition.

A further advantage is the constant data rate, due to the fact that the bandwidth of the transmitted data is defined primarily by the form of the compression module 9a.

FIG. 5 shows an exemplary embodiment of an artificial neural network, ANN, 800. The ANN 800 comprises nodes 820, . . . , 832 and edges 840, . . . , 842, where each edge 840, . . . , 842 is a directed connection from a first node 820, . . . , 832 to a second node 820, . . . , 832. In general, the first node 820, . . . , 832 and the second node 820, . . . , 832 are different nodes 820, . . . , 832. It is also possible, however, that the first node 820, . . . , 832 and the second node 820, . . . , 832 are identical. For example, in FIG. 5 the edge 840 is a directed connection from the node 820 to the node 823, and the edge 842 is a directed connection from the node 830 to the node 832. An edge 840, . . . , 842 from a first node 820, . . . , 832 to a second node 820, . . . , 832 is referred to as an ingoing edge for the second node 820, . . . , 832, and as an outgoing edge for the first node 820, . . . , 832.

In this exemplary embodiment, the nodes 820, . . . , 832 of the ANN 800 can be arranged in layers 810, . . . , 813, where the layers can have an intrinsic order instituted by the edges 840, . . . , 842 between the nodes 820, . . . , 832. In particular, the edges 840, . . . , 842 can be provided only between adjacent layers of nodes. In the example shown, there is an input layer 810, which consists only of the nodes 820, . . . , 822 without any ingoing edges, an output layer 813, which consists only of the nodes 831, 832 without any outgoing edges, and hidden layers 811, 812 between the input layer 810 and the output layer 813. In general, any number of hidden layers 811, 812 can be chosen. In the case of a multilayer perceptron, MLP, this number is at least one. The number of nodes 820, . . . , 822 within the input layer 810 normally relates to the number of input values of the artificial neural network 800, and the number of nodes 831, 832 within the output layer 813 normally relates to the number of output values from the artificial neural network 800.

In particular, each node 820, . . . , 832 of the artificial neural network 800 can be assigned a real number as a value. Here x(n)i denotes the value of the i-th node 820, . . . , 832 of the n-th layer 810, . . . , 813. The values of the nodes 820, . . . , 822 in the input layer 810 equal the input values of the artificial neural network 800. The values of the nodes 831, 832 in the output layer 813 equal the output value of the artificial neural network 800. In addition, each edge 840, . . . , 842 can have a weight, which is a real number. In particular, the weight is a real number within the interval [−1, 1] or within the interval [0, 1,]. Here w(m,n)i,j denotes the weight of the edge between the i-th node 820, . . . , 832 of the m-th layer 810, . . . , 813 and the j-th node 820, . . . , 832 of the n-th layer 810, . . . , 813. In addition, the abbreviation w(n)i,j is defined for the weight w(n,n+1)i,j. In particular, the input values are propagated through the neural network 800 in order to calculate the output values of the neural network 800. In particular, the values of the nodes 820, . . . , 832 of the (n+1)-th layer 810, . . . , 813 can be calculated on the basis of the values of the nodes 820, . . . , 832 of the n-th layer 810, . . . , 813 by

$${x}_{j}^{( n + 1 )} = f ( {\sum }_{i} {x}_{i}^{( n )} {w}_{i , j}^{( n )} ) .$$

where the function f is called a transfer function or activation function. Known transfer functions are step functions, sigmoid functions, for example the logistic function, the generalized logistic function, the hyperbolic tangent, the arc tangent, the error function, the smooth-step function, or rectifier functions. The transfer function is mainly used for normalization. In particular, the values are propagated through the neural network 800 layer by layer, where the values in the input layer 810 are given by the input to the neural network 800, the values in the first hidden layer 811 can be calculated on the basis of the values in the input layer 810 of the neural network 800, the values in the second hidden layer 812 can be calculated on the basis of the values in the first hidden layer 811, and so on.

In order to ascertain the values w(m,n)i,j for the edges, the neural network 800 must be trained by training data. In particular, the training data comprises training input data and training output data (denoted by ti). In a training step, the neural network 800 is applied to the training input data in order to generate calculated output data. In particular, the training data and the calculated output data comprise a number of values equal to the number of nodes in the output layer. In particular, a comparison between the calculated output data and the training data is used to adjust the weights within the neural network 800 recursively (backpropagation algorithm). In particular, the weights are modified according to the following formula:

$${w}_{i , j}^{′ ( n )} = {w}_{i , j}^{( n )} - {γδ}_{j}^{( n )} {x}_{i}^{( n )} ,$$

where γ is a predefined learning rate, and the numbers δ(n)j can be calculated recursively as

$${δ}_{j}^{( n )} = ( {\sum }_{k} {δ}_{k}^{( n + 1 )} {w}_{j , k}^{( n + 1 )} ) {f}^{′} ( {x}_{i}^{( n )} {w}_{i , j}^{( n )} )$$

on the basis of δ(n+1) j if the (n+1)-th layer is not the output layer 813; and as

$${δ}_{j}^{( n )} = ( {x}_{j}^{( n + 1 )} - {t}_{j}^{( n + 1 )} ) {f}^{′} ( {x}_{i}^{( n )} {w}_{i , j}^{( n )} ) ,$$

if the (n+1)-th layer is the output layer 813, where f′ is the first derivative of the activation function, and t(n+1)j is the comparison training value for the j-th node in the output layer 813.

A convolutional neural network, CNN, is an ANN that uses in at least one of its layers a convolution operation instead of a general matrix multiplication. These layers are also referred to as convolutional layers. In particular, a convolutional layer performs a dot product of one or more convolution kernels with the input data of the convolutional layer, where the entries in the one or more convolution kernels are parameters or weights that can be adapted by training. In particular, the Frobenius inner product and the ReLU activation function can be used. A convolutional neural network can comprise additional layers, for instance pooling layers, fully connected layers and/or normalization layers.

The use of convolutional neural networks allows very efficient processing of the input because a convolution operation based on different kernels can extract different image features, and therefore the relevant image features can be determined during the training by adapting the weights of the convolution kernel. Moreover, as a result of the shared use of the weights in the convolution kernels, fewer parameters have to be trained, which prevents overfitting in the training phase and allows faster training or more layers in the network, thereby improving the performance of the network.

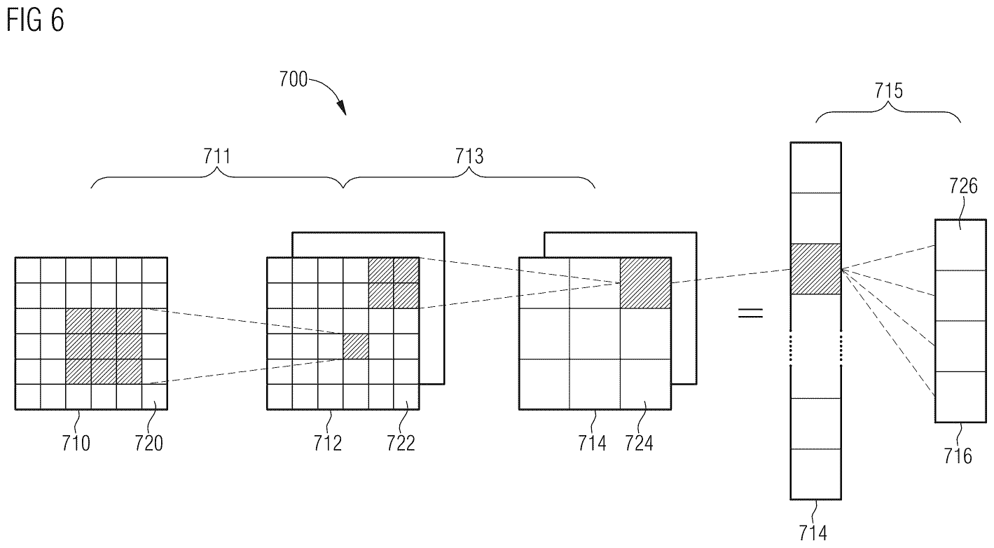

FIG. 6 shows an exemplary embodiment of a convolutional neural network 700. In the embodiment shown, the convolutional neural network 700 comprises an input node layer 710, a convolutional layer 711, a pooling layer 713, a fully connected layer 714 and an output node layer 716, and also hidden node layers 712, 714. Alternatively, the convolutional neural network 700 can also comprise a plurality of convolutional layers 711, a plurality of pooling layers 713 and/or a plurality of fully connected layers 715, and also other types of layers. The layers can be chosen to be in any order, although normally fully connected layers 715 are used as the last layers before the output layer 716.

In a convolutional neural network 700, the nodes 720, 722, 724 in a node layer 710, 712, 714 can be viewed in particular as a d-dimensional matrix or as a d-dimensional image. In particular, in the two-dimensional case, the value of the node 720, 722, 724 with indices i and j in the n-th node layer 710, 712, 714 can be denoted by x(n)[i,j]. The arrangement of the nodes 720, 722, 724 in a node layer 710, 712, 714 as such has no effect, however, on the calculations performed inside the convolutional neural network 700, because these are given solely by the structure and the weights of the edges.

A convolutional layer 711 is a connecting layer between a preceding node layer 710 containing node values x(n−1) and a following node layer 712 containing node values x(n). A convolutional layer 711 is characterized in particular by the structure and the weights of the ingoing edges, which form a convolution operation based on a certain number of kernels. In particular, the structure and the weights of the edges of the convolutional layer 711 can be selected such that the values x(n) of the nodes 722 in the following convolutional layer 712 are calculated as a convolution x(n)=K*x(n−1) based on the values x(n−1) of the nodes 720 in the preceding layer 710, where the convolution*in the two-dimensional case is defined as

$${x}^{( n )} [ i , j ] = ( K * {x}^{( n - 1 )} ) [ i , j ] = {\sum }_{i ′} {\sum }_{j ′} K [ {i}^{′} , {j}^{′} ] \cdot {x}^{( n - 1 )} [ i - {i}^{′} , j - {j}^{′} ] .$$

Here the kernel K is a d-dimensional matrix, in the present example a two-dimensional matrix, which is usually small in comparison with the number of nodes 720, 722, for instance a 3×3 matrix or a 5×5 matrix. This means in particular that the weights of the edges in the convolutional layer 711 are not independent but are selected such that they create the stated convolution equation. In particular, there are only 9 independent weights for a kernel that is a 3×3 matrix, where each entry in the kernel matrix corresponds to an independent weight, regardless of the number of nodes 720, 722 in the preceding node layer 710 and the following node layer 712.

In general, convolutional neural networks 700 use node layers 710, 712, 714 having a multiplicity of channels, in particular as a result of using a multiplicity of kernels in the convolutional layers 711. In these cases, the node layers can be viewed as (d+1)-dimensional matrices, where the first dimension is the index of the channels. The effect of a convolutional layer 711 is then defined in a two-dimensional example as

$${x}_{b}^{( n )} [ i , j ] = {\sum }_{a} ( {K}_{a , b} * {x}_{a}^{( n - 1 )} [ i , j ] = {\sum }_{a} {\sum }_{i ′} {\sum }_{j ′} {K}_{a , b} [ {i}^{′} , {j}^{′} ] \cdot {x}_{a}^{( n - 1 )} [ i - {i}^{′} , j - {j}^{′} ] ) ,$$

where xₐ⁽ⁿ⁾ corresponds to the a-th channel of the preceding node layer 710, x_{b}⁽ⁿ⁾ corresponds to the b-th channel of the subsequent node layer 712, and K_{a,b} corresponds to one of the kernels. If a convolutional layer 711 acts on a preceding node layer 710 having A-channels and outputs a subsequent node layer 712 having B-channels, there are A·B independent d-dimensional kernels K_{a,b}.

In general, activation functions can be used in convolutional neural networks 700. In this embodiment, ReLU (rectified linear unit) is used, with R(z)=max(0, z), so that the effect of the convolutional layer 711 in the two-dimensional example is

$${x}_{b}^{( n )} [ i , j ] = R ( {\sum }_{a} ( {K}_{a , b} * {x}_{a}^{( n - 1 )} [ i , j ] ) = R {( \sum }_{a} {\sum }_{i ′} {\sum }_{j ′} {K}_{a , b} [ {i}^{′} , {j}^{′} ] \cdot {x}_{a}^{( n - 1 )} [ i - {i}^{′} , j - {j}^{′} ] )$$

It is also possible to use other activation functions, for instance ELU (exponential linear unit), leaky ReLU, sigmoid, tanh or softmax.

In the embodiment shown, the input layer 710 includes 36 nodes 720, which are arranged in a two-dimensional 6×6 matrix. The first hidden node layer 712 contains 72 nodes 722, which are arranged as two two-dimensional 6×6 matrices, with each of the two matrices being the result of convolving the values in the input layer with a 3×3 kernel in the convolutional layer 711. As an equivalent, the nodes 722 in the first hidden node layer 712 can be interpreted as a three-dimensional 2×6×6 matrix, where the first dimension corresponds to the channel dimension.

An advantage of using convolutional layers 711 is that a spatially local correlation in the input data can be exploited by imposing a local connectivity pattern between the nodes in neighboring layers, in particular by each node being connected just to a small region of the nodes in the previous layer.

A pooling layer 713 is a connecting layer between a previous node layer 712 containing node values x(n−1) and a subsequent node layer 714 containing node values x(n). A pooling layer 713 can be characterized in particular by the structure and the weights of the edges and by the activation function, which form a pooling operation based on a non-linear pooling function f. For example, in the two-dimensional case, the values x(n) of the nodes 724 in the subsequent node layer 714 are calculated on the basis of the values x(n−1) of the nodes 722 in the anterior node layer 712 as follows

$${x}_{b}^{( n )} [ i , j ] = f ( {x}_{b}^{( n - 1 )} [ {id}_{1} , {jd}_{2} ] , … , {x}_{b}^{( n - 1 )} [ ( i + 1 ) {d}_{1} - 1 , ( j + 1 ) {d}_{2} - 1 ] ) .$$

In other words, using a pooling layer 713 can reduce the number of nodes 722, 724 by replacing a number of d1-d2 adjacent nodes 722 in the previous node layer 712 with a single node 722 in the subsequent node layer 714, which is calculated as a function of the values of said number of adjacent nodes. In particular, the pooling function f can be the max function, the mean value, or the L2 norm. In particular, the weights of the ingoing edges are fixed for a pooling layer 713 and not modified by the training.

The advantage of using a pooling layer 713 is that it reduces the number of nodes 722, 724 and the number of parameters. This results in a reduction in the calculation effort in the network and acts as a check on overfitting.

In the embodiment shown, the pooling layer 713 is a max pooling layer, in which four adjacent nodes are replaced by just one node, where the value is the maximum of the values of the four adjacent nodes. The max pooling is applied to each d-dimensional matrix of the previous layer. In this embodiment, the max pooling is applied to each of the two-dimensional matrices, thereby reducing the number of nodes from 72 to 18.

In general, the last layers of a convolutional neural network 700 are fully connected layers 715. A fully connected layer 715 is a connecting layer between a previous node layer 714 and a subsequent node layer 716. A fully connected layer 713 can be characterized in that a majority of, in particular all, edges between the nodes 714 in the previous node layer 714 and the nodes 716 in the subsequent node layer are present, and the weight of each of these edges can be adjusted individually.

In this embodiment, the nodes 724 in the preceding node layer 714 of the fully connected layer 715 are represented both as two-dimensional matrices and also additionally as non-related nodes, which are shown as a line of nodes, where the number of nodes has been reduced for better visualization. This process is also referred to as flattening. In this embodiment, the number of nodes 726 in the subsequent node layer 716 of the fully connected layer 715 is less than the number of nodes 724 in the previous node layer 714. Alternatively, the number of nodes 726 can also be the same or larger.

In addition, in this embodiment, the softmax activation function is used in the fully connected layer 715. By applying the softmax function, the sum of the values of all the nodes 726 in the output layer 716 equals 1, and all the values of all the nodes 726 in the output layer 716 are real numbers between 0 and 1. In particular when using the convolutional neural network 700 for categorizing input data, the values of the output layer 716 can be interpreted as the probability of the input data falling into one of the different categories.

In particular, convolutional neural networks 700 can be trained on the basis of the backpropagation algorithm. Regularization methods can be employed in order to avoid overfitting, for example dropout of nodes 720, . . . , 724, stochastic pooling, the use of artificial data, weight decay based on the L1 or L2 norm, or max norm constraints.

Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one of more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SOC), a programmable logic unit, a microprocessor, or any other device capable of responding to and executing instructions in a defined manner. Portions of the example embodiments and corresponding description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, etc.) that may be block diagrams, implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, code, program instructions, some or combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. A computer-implemented method for compressing data from a system for computed tomography (CT), the system for CT including an X-ray detector containing a detector pixel array, the method comprising:
obtaining at least one first dataset, the at least one first dataset containing a pixel value for each of a first multiplicity of associated detector pixels of the detector pixel array, each pixel value relates to an intensity of X-ray radiation incident on the associated detector pixel; and
generating compressed data by applying a first compression module to first input data, the first input data containing the at least one first dataset, the first compression module including a trained first machine learning model (MLM), the first MLM being trained to compress input data via the first compression module, and to reconstruct at least some of the input data based on the compressed data via a first decompression module of the first MLM.

2. The computer-implemented method of claim 1, wherein the X-ray detector is a photon-counting X-ray detector, and the at least one first dataset contains for each of the first multiplicity of associated detector pixels, as an associated pixel value, a corresponding number of count events.

3. The computer-implemented method of claim 2, wherein at least one of
the count events correspond to a specified energy threshold, and the at least one first dataset contains an associated number of further count events for each of the first multiplicity of associated detector pixels, wherein the further count events correspond to a specified further energy threshold, the specified further energy threshold differs from the energy threshold;
the at least one first dataset contains a number of coincidence count events for each of the first multiplicity of associated detector pixels; or
the at least one first dataset contains a number of paralysis compensation events for each of the first multiplicity of associated detector pixels.

4. The computer-implemented method of claim 1, wherein at least one of
the at least one first dataset contains a cluster value for each of two or more associated pixel clusters of the first multiplicity of associated detector pixels; or
the at least one first dataset contains a further pixel value for each of the first multiplicity of associated detector pixels, the pixel value relates to an intensity of X-ray radiation incident on the associated detector pixel, wherein the associated pixel value and the associated further pixel value correspond to different data acquisition time intervals.

5. The computer-implemented method of claim 1, wherein
a context dataset is obtained, the context dataset relates to a generation of the at least one first dataset; and
the first input data includes the context dataset.

6. The computer-implemented method of claim 5, wherein at least one of
the context dataset includes a spatial position of the first multiplicity of detector pixels within the detector pixel array;
the context dataset includes operating parameters of an X-ray source of the system for CT;
the context dataset includes patient information; or
the context dataset includes information about preprocessing of detector raw data for generating the at least one first dataset.

7. The computer-implemented method of claim 1, further comprising:
obtaining a second dataset, the second dataset containing a pixel value for each of a second multiplicity of associated detector pixels of the detector pixel array, each pixel value relates to an intensity of X-ray radiation incident on the associated detector pixel, the first multiplicity of associated detector pixels is a first portion of the detector pixel array and the second multiplicity of associated detector pixels is a second portion of the detector pixel array; and
generating further compressed data by applying a second compression module to second input data, the second input data containing the second dataset, wherein the second compression module including a trained second MLM, the second MLM being trained to compress the second input data via the second compression module, and to reconstruct at least some of the second input data based on the compressed second input data via a second decompression module of the second MLM.

8. A computer-implemented method for decompressing compressed data from a system for computed tomography (CT), the system for CT including an X-ray detector containing a detector pixel array, the method comprising:
obtaining compressed data via a first compression module; and
generating at least one reconstructed dataset by applying a first decompression module to the compressed data, the first decompression module including a trained first machine learning model (MLM), the first MLM being trained to compress input data via a first compression module of the first MLM, and to reconstruct at least some of the input data based on the compressed input data via the first decompression module.

9. The computer-implemented method of claim 8, wherein the compressed data is generated by,
obtaining at least one first dataset, the at least one first dataset containing a pixel value for each of a first multiplicity of associated detector pixels of the detector pixel array, each pixel value relates to an intensity of X-ray radiation incident on the associated detector pixel; and
generating the compressed data by applying a first compression module to first input data, the first input data containing the at least one first dataset, the first compression module including a trained first machine learning model (MLM), the first MLM being trained to compress input data via the first compression module, and to reconstruct at least some of the input data based on the compressed input data via a first decompression module of the first MLM.

10. The computer-implemented method of claim 8, wherein
at least one reduced dataset is generated by applying a further first decompression module of the trained first MLM to the compressed data; and
the at least one reduced dataset contains a smaller amount of data than the at least one reconstructed dataset.

11. A computer-implemented training method for a first MLM for use in the computer-implemented method of claim 1, the computer-implemented training method comprising:
obtaining a first training dataset;
generating second compressed data by applying the first compression module to first input training data, the first input training data containing the first training dataset;
generating decompressed data by applying the first decompression module to the second compressed data;
evaluating a specified loss function based on the first input training data and the decompressed data; and
updating the first MLM based on a result of the evaluation of the loss function.

12. The computer-implemented training method of claim 11, wherein
the at least one first training dataset is obtained in a form of at least one sinogram;
the decompressed data is generated in the form of a further sinogram; and
the loss function quantifies a deviation of the further sinogram from the sinogram.

13. The computer-implemented training method of claim 12, wherein
the generating the compressed data, the generating the decompressed data, and the evaluating the loss function are performed during a first training phase;
a CT reconstruction is generated based on the sinogram, and a further CT reconstruction is generated based on the further sinogram; and
during a second training phase, a specified further loss function is evaluated based on the CT reconstruction and the further CT reconstruction, and the MLM updated based on a result of the evaluation of the further loss function, the second training phase following the first training phase.

14. A data processing system having:
at least one data processing device configured to perform the method of claim 1.

15. A system for computed tomography comprising:
a scanner unit including an X-ray detector containing a detector pixel array; and
at least one data processing device configured to perform the method of claim 1.

16. The system for computed tomography of claim 15, wherein at least one of
the X-ray detector contains a multiplicity of integrated circuits, wherein each of the integrated circuits contains a portion of the detector pixel array, and the first MLM is implemented on one of the multiplicity of integrated circuits; or
the X-ray detector contains a multiplicity of integrated circuits, wherein each of the integrated circuits is configured to at least one of control a portion of the detector pixel array or to obtain data from the portion of the detector pixel array, and the first MLM is implemented on one of the multiplicity of integrated circuits.

17. A non-transitory computer readable medium comprising commands, when executed by at least one data processing device of a system, cause the system to perform the method of claim 1.
